(19) United States
(12) Patent Application Publication
(10) Pub. No.: US 2008/0238315 A1
(43) Pub. Date: Oct. 2, 2008

(54) PLASMA DISPLAY PANEL

(76) Inventors: Fusao Hojo, Tokai (JP); Takashi Naito, Funabashi (JP); Hiroki Yamamoto, Hitachi (JP); Yuichi Sawai, Miyazaki (JP); Motoyuki Miyata, Hitachinaka (JP); Mitsuo Hayashibara, Hitachinaka (JP); Keiichi Kanazawa, Ome (JP); Hideto Momose, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/016,242

(22) Filed: Jan. 18, 2008

(30) Foreign Application Priority Data
Mar. 30, 2007 (JP) 2007-090526

(51) Int. Cl. H01J 17/49

(52) U.S. Cl. 313/582

(57) ABSTRACT

To prevent occurrence of abnormal discharge which would reduce the quality of images in a PDP. At least one of an address electrode, a bus electrode, a bus main electrode, and a black electrode of a display electrode formed on a substrate is formed of metal particles and high-resistance glass to dissipate charge accumulated on a dielectric through the high-resistance glass and to prevent charging in a glass component itself, thereby reducing abnormal discharge. The high-resistance glass is preferably realized by vanadium phosphate glass containing vanadium, phosphorus, antimony, and barium. The metal particles desirably contain flaky particles.

### FIELD OF THE INVENTION

The present invention relates to a plasma display panel.

### BACKGROUND OF THE INVENTION

Plasma display panels (hereinafter abbreviated as PDPS) have been developed as a flat image display with a large screen and high definition and are widely used.

A PDP has a configuration in which two substrates are opposed with an interval of approximately 100 to 200 μm between them, a plurality of spacers are placed between the substrates, and the peripheries of the substrates are sealed by an adhesive. The space surrounded by the spacers and the substrates is referred to as a cell. A phosphor which can emit light of a color of red, blue, or green is put in one cell. Three cells for the three colors constitute one pixel.

A display electrode is provided for a front substrate, while an address electrode (also referred to as a data electrode) is provided for a rear substrate perpendicularly to the display electrode. The display electrode is formed of a transparent electrode made of ITO or the like and a non-transparent electrode. This is because only the transparent electrode made of ITO or the like does not cause a sufficiently high voltage pulse due to high electric resistance, thereby resulting in difficulty of display. The non-transparent electrode is made of a metal material having low electric resistance and is desirably colored as close to black as possible in order to prevent reflection of exterior light to reduce contrast. Patent Document 1 describes a non-transparent electrode configured to have two layers.

Patent Document 1: JP-A-4-272634 (abst.)

### BRIEF SUMMARY OF THE INVENTION

In a PDP, address discharge is performed between an address electrode and a display electrode of a cell which is to be lit, so that space charge is accumulated in the cell. Next, a predetermined voltage is applied between the paired display electrode and address electrode to cause display discharge only in the cell having the space charge accumulated through the address discharge to emit ultraviolet rays. In this manner, images are displayed. The space charge is accumulated on a glass component contained in a spacer, a dielectric layer, or the electrodes. As the accumulated amount of charge is increased, abnormal discharge is more likely to occur due to a large voltage to reduce the quality of images.

It is an object of the present invention to provide a PDP capable of reducing the occurrence of abnormal discharge.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows the configuration of a PDP;

FIG. 2 shows an exemplary configuration of a transparent electrode and a bus electrode;

FIG. 3 shows an exemplary configuration of a transparent electrode, a bus main electrode, and a black electrode; and

FIGS. 4(a) and 4(b) are perspective views showing an exemplary configuration of a PDP device.

### DESCRIPTION OF REFERENCE NUMERALS

1 FRONT SUBSTRATE, 2 REAR SUBSTRATE, 3 DISPLAY ELECTRODE, 4 ADDRESS ELECTRODE, 5 PHOSPHOR, 6 PHOSPHOR, 7 PHOSPHOR, 8 SPACER, 9 DIELECTRIC LAYER, 10 DIELECTRIC LAYER, 11 PROTECTING LAYER, 12 BLACK MATRIX, 13 SEALING PORTION, 14 TRANSPARENT ELECTRODE, 15 BUS ELECTRODE, 16 BLACK ELECTRODE, 17 BUS MAIN ELECTRODE, 18 ULTRAVIOLET RAYS

### DETAILED DESCRIPTION OF THE INVENTION

The present invention relates to provide a PDP including a front substrate and a rear substrate which are provided opposite to each other, an address electrode and a dielectric layer which are provided on the rear substrate, a display electrode and a dielectric layer which are provided on the front substrate, a plurality of spacers placed between the front substrate and the rear substrate, and a phosphor filled in space surrounded by the plurality of spacers, the front substrate, and the rear substrate. The display electrode is formed of a transparent electrode and a non-transparent electrode. The peripheries of the front substrate and the rear substrate are sealed. At least one of the non-transparent electrode and the address electrode includes metal particles and high-resistance glass for binding the metal particles.

The present invention also relates to provide a PDP including a front substrate and a rear substrate which are provided opposite to each other, an address electrode and a dielectric layer which are provided on the rear substrate, a display electrode and a dielectric layer which are provided on the front substrate, a plurality of spacers placed between the front substrate and the rear substrate, and a phosphor fulled in space surrounded by the plurality of spacers, the front substrate, and the rear substrate. The display electrode is formed of a transparent electrode, a black electrode provided on the transparent electrode, and a bus main electrode provided on the black electrode. The peripheries of the front substrate and the rear substrate are sealed. At least one of the black electrode, the bus main electrode, and the address electrode includes metal particles and high-resistance glass for binding the metal particles.

Abnormal discharge occurs from charge remaining in the spacer or the dielectric. The abnormal discharge can be prevented by providing conductivity for the glass component of the electrode bonded to the dielectric to dissipate the charge accumulated in the dielectric and to avoid charging in the glass component itself contained in the electrode.

According to one aspect of the present invention, the PDP includes the display electrode formed of the transparent electrode and the non-transparent bus electrode on the front substrate and the address electrode on the rear substrate. One or both of the bus electrode and the address electrode contain the metal particles and the high-resistance glass.

According to another aspect of the present invention, the PDP includes the display electrode formed of the transparent electrode and the non-transparent electrode formed of the black electrode and the bus main electrode on the front substrate and the address electrode on the rear substrate. At least one of the bus main electrode, the black electrode, and the address electrode contains the metal particles and the high-resistance glass.

Vanadium phosphate glass is desirably used for the high-resistance glass. Especially, vanadium phosphate glass containing vanadium, phosphorus, antimony, and barium is desirable. Since vanadium phosphate glass is black in color, and particularly, glass containing vanadium, phosphorus, antimony, and barium has a conductivity of 1×10⁶ to 10¹¹, local charging in the glass portion can be prevented to reduce abnormal discharge effectively.

The metal particles preferably contain flaky particles, and more preferably, the contained flaky particle has a diameter of 2 μm or more. The contained flaky particles avoid an increase in electric resistance due to reaction between the glass component and the metal particles.

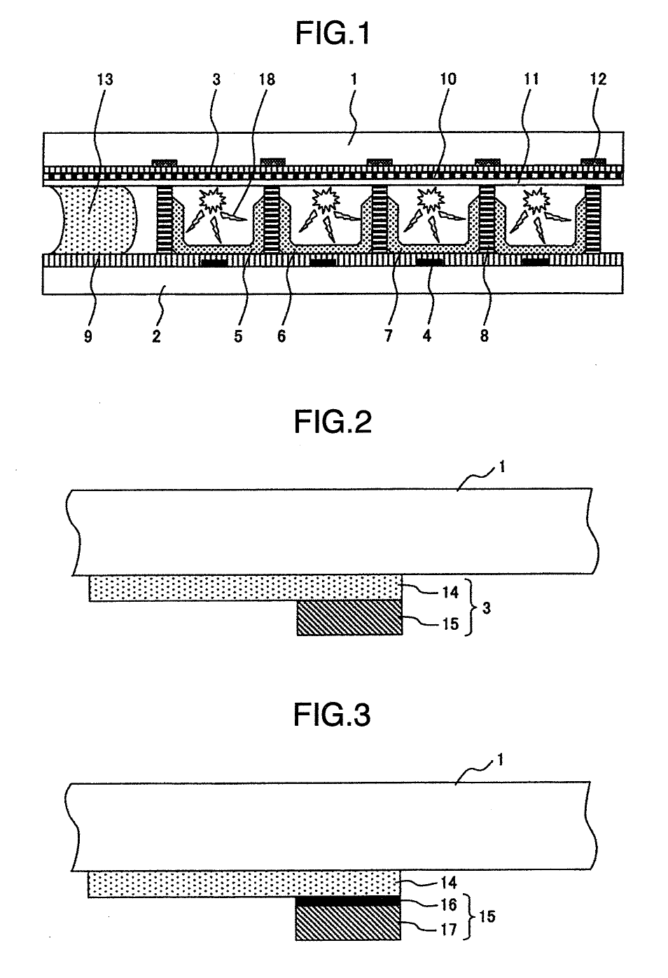

FIG. 1 schematically shows the configuration of a PDP. The PDP is a display device in which discharge is produced in very small space filled with a rare gas such as neon and xenon to cause a phosphor filled therein to emit light.

In the PDP, a front substrate 1 and a rear substrate 2 are opposed with an interval of approximately 100 to 200 μm between them. The interval between the substrates is held by spacers 8. The peripheries of the substrates are sealed by an adhesive mainly made of glass. A rare gas is filled into internal space surrounded by a sealing portion 13. A very small space defined by the substrates and the spacers is referred to as a cell. Phosphors 5, 6, and 7 of three colors of red, green, and blue (hereinafter referred to as R, G, and B) are individually filled in the cells. The cells for the three colors constitute one pixel to emit light in the respective colors.

On the side of the rear substrate 2 of the PDP, an address electrode (or a data electrode) 4 is formed on the substrate, and a dielectric layer 9 is formed over the address electrode. The dielectric layer 9 is provided for controlling electric current of the address electrode 4 and for protection against breakdown.

The spacer 8 in a strip shape or a grid shape having openings is formed on the dielectric layer 9. The spacers are arranged in a linear form (stripe form or rib form) or a grid form. The spacers are formed by applying glass paste with a printing technique or by shaving a thick film with a sandblast technique, for example. The phosphors 5, 6, and 7 are applied to the wall surfaces of the cells defined by the spacers 8.

A display electrode 3 is formed on the side of the front substrate 1, a dielectric layer 10 is formed over the display electrode 3, and a protecting layer 11 is formed over the dielectric layer 10. The display electrode 3 is disposed perpendicularly to the address electrode formed on the rear substrate. The dielectric layer 10 protects the electrode and has a memory function of forming wall charge in discharge. The protecting layer 11 is provided for protecting the electrode and the like from plasma and is generally formed of MgO film. A typical PDP further includes a black matrix 12 (black-color layer) having an opening corresponding to each pixel on the side of the front substrate. This is because the black color is seen from the side of the front substrate to advantageously improve contrast of images. The black matrix 12 may be formed above or below the display electrode 3.

The rear substrate 2 and the front substrate 1 are opposed with precise alignment and the peripheries thereof are bonded. A glass adhesive is used for the bonding. While the panel is heated, the gas contained therein is exhausted and a rare gas is filled therein.

FIGS. 2 and 3 show exemplary structures of the display electrode 3. The display electrode 3 is formed of a transparent electrode 14 and a bus electrode 15. A film of indium-tin oxide (ITO film) or the like is used for the transparent electrode 14. A metal wire or the like is used for the bus electrode.

FIG. 2 shows an example of the display electrode including a transparent electrode 14 and a bus electrode 15 placed one on another. Since the transparent electrode 14 formed of the ITO or the like has high electric resistance, it does not provide a sufficiently high voltage pulse and thus favorable display is difficult. For this reason, the bus electrode 15 having low electric resistance is provided on the transparent electrode 14 to facilitate display. The bus electrode 15 is made of a metal material having low electric resistance and is desirably colored as close to black as possible in order to prevent reflection of exterior light to reduce contrast.

FIG. 3 shows another example of the display electrode consisting of a transparent electrode 14, a bus main electrode 17, and a black electrode 16. A bus electrode 15 may be formed of a single layer but may have a structure of two layers with different electric resistance values. Since the bus electrode is desirably colored as close to black as possible, a black pigment is added to the electrode. However, the addition of the black pigment increases the electric resistance. To address this, the bus electrode is divided into two layers such that the black electrode 16 is formed in contact with the transparent electrode 14 and the bus main electrode 17 having a lower electric resistance value is formed in contact with the black electrode.

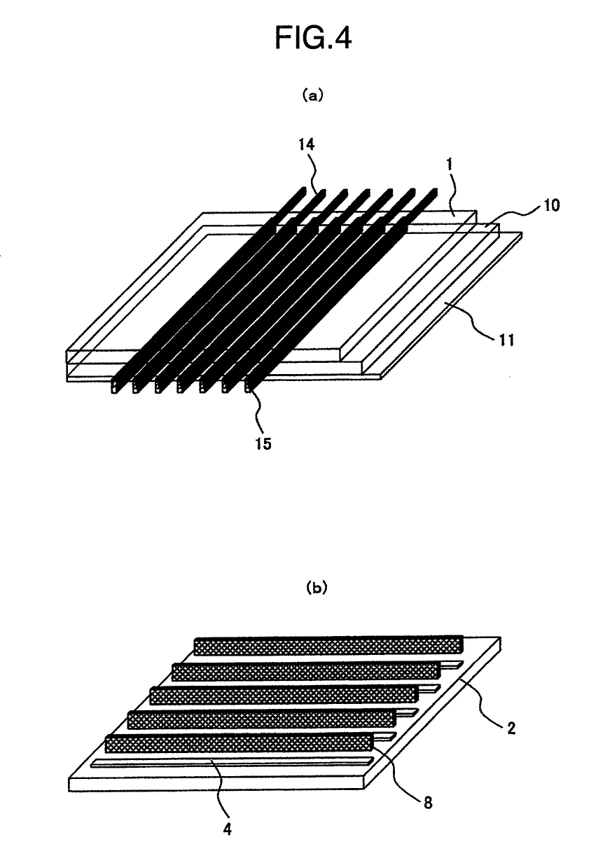

FIG. 4 shows exemplary structures of the PDP. Specifically, FIG. 4(a) shows an exemplary structure of the front substrate side, while FIG. 4(b) shows an exemplary structure of the rear substrate side. The regularly arranged electrodes are provided for the substrates as shown.

In the PDP, the phosphorus 5, 6, and 7 of the three colors of R, G, and B are filled between the spacers 8 formed between the front substrate 1 and the rear substrate 2, a rare gas such as xenon sealed in the cell is ionized to cause emission of ultraviolet rays, and the ultraviolet rays cause the phosphorus to emit light, thereby displaying an image. Specifically, a voltage is applied to a point where the address electrode intersects the display electrode to cause discharge in the rare gas to change the gas into plasma, and the ultraviolet rays produced when the rare gas returns from the plasma to the original state are used to cause the phosphor to emit light.

The address electrode, the bus electrode, the bus main electrode, and the black electrode used in the PDP can be formed by performing screen printing of conductive paste containing metal and then calcination, or by applying photosensitive conductive paste and exposing it to light through a pattern mask and then performing development and calcination. However, the present invention is not limited to these methods of formation.

The conductive paste used in forming the electrodes is typically made of metal particles, glass frit, and an organic vehicle. The glass frit is mixed in order to enhance adhesion between the formed metal pattern and the substrate or dielectric layer. The electrodes need to be formed at low temperature in the calcination to prevent damage to the substrate. The calcination at low temperature requires the use of glass frit having a low glass transition temperature and a low glass softening point, and conventionally, glass frit containing lead was used. However, in view of environmental protection, glass frit containing no lead is demanded. Bi₂O₃-based glass frit has a low glass transition temperature and a low glass softening point, but is a dielectric and causes abnormal discharge due to local accumulation of charge on glass.

To prevent abnormal discharge, the address electrode, the bus electrode, or the bus main electrode of the bus electrode having the two-layered structure in the present invention is made of metal particles and high-resistance glass. Preferably, the high-resistance glass contains vanadium, phosphorus, antimony, and barium. In this case, the metal particles desirably contain flaky particles with a diameter of 2 μm or more. If the metal particles contain no flaky particles but contain only particles of spherical shape or the like, bonding between the metal particles is insufficient to increase electric resistance. If the metal particle has a smaller diameter, the metal particles react with the glass component to produce a larger amount of M-V—O compound, M-P—O compound, and M-Sb—O compound (where M represents metal) to increase electric resistance.

The flaky particle desirably has an aspect ratio of three or more which is calculated by dividing the particle diameter by the average thickness of the particles. The particle diameter refers to the longer diameter of a particle. More desirably, the flaky particle has a diameter of 2 μm or more. More desirably, the metal contains 50 to 90 wt % of the flaky particles.

Metals with conductivity can be used for the metal particles, and particularly, gold, silver, palladium, nickel, copper, aluminum, and platinum are preferable. A mixture or an alloy of two or more metals can be used. The metal particles may be formed to have two layers. When the particles have the two-layered structure, a metal on the outer side is preferably more resistant to oxidation or reaction with the glass component than a metal on the inner side. This can prevent oxidation or reaction of the inner metal with the glass component. In the metal particles having the two-layered structure, the metal on the surface of the particle is desirably contained at a ratio (weight ratio) of 1:200 or more to the metal on the inner side of the particle (metal on the particle surface:metal on the inner side) in terms of prevention of reaction with the glass component and oxidation.

The high-resistance glass is preferably made of vanadium phosphate glass. Particularly, glass containing vanadium, phosphorus, antimony, and barium is preferable. Vanadium, phosphorus, antimony, and barium contained as the glass component can provide glass having a low glass transition temperature, a low glass softening point, and an electric resistance of approximately 1×10⁷ to 10¹¹ Ωcm. More desirably, the glass is made of 45 to 65 wt % of V₂O₅, 15 to 30 wt % of P₂O₅, 2 to 25 wt % of BaO, and 5 to 30 wt % of Sb₂O₃.

Vanadium phosphate glass has a lower glass softening point as it contains a larger weight ratio of V₂O₅/P₂O₅ in the glass components, that is, as the ratio of V₂O₅ to P₂O₅ is larger. BaO is a network-modifier oxide and has the effect of stabilizing vanadium phosphate glass, so that it is an essential component and is contained by 2 to 25 wt %. Sb₂O₃ has the effect of increasing water resistance and thus is an essential component and is contained by 5 to 30 wt %.

The address electrode is desirably made of 70 to 95 wt % of the metal and 5 to 30 wt % of the glass. A larger amount of the metal is desirable since it can reduce electric resistance, but a smaller amount of the glass reduces adhesion to the substrate and the dielectric.

The bus electrode or the bus main electrode desirably contains a coloring pigment so that it is colored as close to black as possible. Desirably, it contains 70 to 95 wt % of the metal, 5 to 30 wt % of the glass, and 0 to 25 wt % of the coloring pigment. A larger amount of the metal is desirable since it can reduce electric resistance, but a smaller amount of the glass reduces adhesion to the substrate and the dielectric and also fails to prevent reflection sufficiently to reduce contrast of images.

The black electrode preferably contains a coloring pigment, and preferably contains 50 to 80 wt % of the metal, 5 to 40 wt % of the glass, and 0 to 40 wt % of the coloring pigment. A larger amount of the metal is desirable since it can reduce electric resistance, but a smaller amount of the glass reduces adhesion to the substrate and the dielectric and also fails to prevent reflection sufficiently to reduce contrast of images.

Any coloring pigment may be used as long as it is a particle presenting a black color. An oxide of Cr, Co, Cu, Ni, Fe, Mn or the like may be used alone or a combination of two or more of them may be used. However, the present invention is not limited to the materials herein mentioned.

Next, the present invention will be described in detail with reference to Examples.

### EXAMPLE 1

Conductive paste was subjected to screen printing to form a pattern which was then dried and calcinated to provide an address electrode, a bus electrode, a bus main electrode, and a black electrode. The conductive paste was made of an organic solvent, a vehicle, metal particles, and glass frit. The composition and shape of the glass frit and metal particles influence the resulting electrodes of a PDP.

Table 1 shows electrode samples formed by using the conductive paste prepared for the address electrode. Table 2 shows electrode samples formed by using the conductive paste prepared for the bus or bus main electrode. Table 3 shows electrode samples formed by using the conductive paste prepared for the black electrode. Cobalt tetroxide was used as the coloring pigment. The volume resistivity, the presence or absence of peeling, and the blackness were evaluated.

TABLE 1

composition (wt %)

metal particles

| | |
|---|---|
| average | properties |

| | | | | | | | flaky | diameter | | presence or |
|---|---|---|---|---|---|---|---|---|---|---|
| | | | | | | metal | particle | of flaky | resistance | absence of |
| | glass frit | | | | metal | content in | content in | particles | value | peeling from |
| | V₂O₅ | P₂O₅ | BaO | Sb₂O₃ | species | electrode | metal | (μm) | (10⁻⁶ Ω-cm) | substrate |
| sample 1 | 6 | 2.5 | 0.7 | 0.8 | Ag | 90 | 60 | 3 | 2.0 | ◯ |
| sample 2 | 7 | 2.4 | 0.3 | 0.3 | Ag | 90 | 60 | 3 | 1.8 | Δ |
| sample 3 | 4 | 3 | 1.5 | 1.5 | Ag | 90 | 60 | 3 | 2.3 | Δ |
| sample 4 | 4.5 | 1 | 2.5 | 2 | Ag | 90 | 60 | 3 | 2.0 | Δ |
| sample 5 | 6 | 3.5 | 0.2 | 0.3 | Ag | 90 | 60 | 3 | 2.4 | ◯ |
| sample 6 | 5 | 2.5 | 0 | 2.5 | Ag | 90 | 60 | 3 | not formed into glass: | |
| | | | | | | | | | unusable | |
| sample 7 | 5 | 2.5 | 2.5 | 0 | Ag | 90 | 60 | 3 | not formed into glass: | |
| | | | | | | | | | unusable | |
| sample 8 | 6 | 2.5 | 0.7 | 0.8 | Ag | 90 | 40 | 3 | 8.3 | ◯ |
| sample 9 | 36 | 15 | 4.2 | 4.8 | Ag | 40 | 60 | 3 | 4.0 × 10¹⁰ | ◯ |
| sample 10 | 6 | 2.5 | 0.7 | 0.8 | Au | 90 | 60 | 3 | 2.8 | ◯ |
| sample 11 | 6 | 2.5 | 0.7 | 0.8 | Ag | 90 | 0 | 3 | 25.8 | ◯ |
| sample 12 | 6 | 2.5 | 0.7 | 0.8 | Ag | 90 | 60 | 1 | 10.6 | ◯ |
| sample 13 | 6 | 2.5 | 0.7 | 0.8 | Au/Ag | 90 | 60 | 3 | 1.4 | ◯ |

| | | | | | | | |
|---|---|---|---|---|---|---|---|
| sample 14 | Bi₂O₃ 8 wt %, B₂O₃ 1 wt %, | Ag | 90 | 60 | 3 | 8.9 | ◯ |
| | SiO₂ 1 wt % | | | | | | |

TABLE 2

| | Composition (wt %) | | | | | | | | | | | |
|---|---|---|---|---|---|---|---|---|---|---|---|---|
| | | | | | metal particles | | | | | properties | | |
| | | | | | | | | average | | | presence or | |
| | | | | | | metal | flaky | diameter | | | absence of | |
| | | | | | | content | particle | of flaky | | resistance | peeling | |
| | glass frit | | | | | in | content in | particles | coloring | value | from | |
| | V₂O₅ | P₂O₅ | BaO | Sb₂O₃ | metal | electrode | metal | (μm) | pigment | (10⁻⁴ Ω-cm) | substrate | L * value |
| sample 15 | 6 | 2.5 | 0.7 | 0.8 | Ag | 85 | 60 | 3 | 5 | 3.1 | ◯ | 15 |
| sample 16 | 7 | 2.4 | 0.3 | 0.3 | Ag | 85 | 60 | 3 | 5 | 2.6 | Δ | 13 |
| sample 17 | 4 | 3 | 1.5 | 1.5 | Ag | 85 | 60 | 3 | 5 | 2.8 | Δ | 19 |
| sample 18 | 4.5 | 1 | 2.5 | 2 | Ag | 85 | 60 | 3 | 5 | 3.0 | Δ | 15 |
| sample 19 | 6 | 3.5 | 0.2 | 0.3 | Ag | 85 | 60 | 3 | 5 | 3.4 | ◯ | 18 |
| sample 20 | 5 | 2.5 | 0 | 2.5 | Ag | 85 | 60 | 3 | 5 | not formed into glass: unusable | | |
| sample 21 | 5 | 2.5 | 2.5 | 0 | Ag | 85 | 60 | 3 | 5 | not formed into glass: unusable | | |
| sample 22 | 6 | 2.5 | 0.7 | 0.8 | Ag | 85 | 40 | 3 | 5 | 10.2 | ◯ | 15 |
| sample 23 | 33 | 14 | 3.7 | 4.3 | Ag | 40 | 60 | 3 | 5 | 4.3 × 10¹⁰ | ◯ | 10 |
| sample 24 | 6 | 2.5 | 0.7 | 0.8 | Au | 85 | 60 | 3 | 5 | 3.2 | ◯ | 15 |
| sample 25 | 6 | 2.5 | 0.7 | 0.8 | Ag | 85 | 0 | 3 | 5 | 33.6 | ◯ | 15 |
| sample 26 | 6 | 2.5 | 0.7 | 0.8 | Ag | 85 | 60 | 1 | 5 | 7.6 | ◯ | 15 |
| sample 27 | 6 | 2.5 | 0.7 | 0.8 | Au/Ag | 85 | 60 | 3 | 5 | 2.0 | ◯ | 15 |

| | | | | | | | | | |
|---|---|---|---|---|---|---|---|---|---|
| sample 28 | Bi₂O₃ 8 wt %, B₂O₃ 1 wt %, | Ag | 85 | 60 | 3 | 5 | 7.9 | ◯ | 30 |
| | SiO₂ 1 wt % | | | | | | | | |

TABLE 3

| | composition (wt %) | | | | | | | | | properties | | |
|---|---|---|---|---|---|---|---|---|---|---|---|---|
| | | | | | metal particles | | | | | | presence or | |
| | | | | | | | | average | | | absence of | |
| | | | | | | metal | flaky | diameter | | | peeling | |
| | | | | | | content | particle | of flaky | | resistance | from | |
| | glass frit | | | | | in | content | particles | coloring | value | transparent | |
| | V₂O₅ | P₂O₅ | BaO | Sb₂O₃ | metal | electrode | in metal | (μm) | pigment | (10⁵-cm) | electrode | L * value |
| sample 29 | 30 | 12.5 | 3.5 | 4 | Ag | 40 | 60 | 3 | 10 | 3.8 | ◯ | 15 |
| sample 30 | 35 | 12 | 1.5 | 1.5 | Ag | 40 | 60 | 3 | 10 | 4.1 | Δ | 13 |
| sample 31 | 20 | 15 | 7.5 | 7.5 | Ag | 40 | 60 | 3 | 10 | 5.0 | Δ | 19 |
| sample 32 | 22.5 | 5 | 12.5 | 10 | Ag | 40 | 60 | 3 | 10 | 4.2 | Δ | 15 |
| sample 33 | 30 | 17.5 | 1 | 1.5 | Ag | 40 | 60 | 3 | 10 | 6.3 | ◯ | 18 |
| sample 34 | 25 | 12.5 | 0 | 12.5 | Ag | 40 | 60 | 3 | 10 | not formed into glass: unusable | | |
| sample 35 | 25 | 12.5 | 12.5 | 0 | Ag | 40 | 60 | 3 | 10 | not formed into glass: unusable | | |
| sample 36 | 30 | 12.5 | 3.5 | 4 | Ag | 40 | 40 | 3 | 10 | 9.6 | ◯ | 15 |
| sample 37 | 54 | 18 | 9 | 9 | Ag | 0 | 0 | 3 | 10 | 95.2 | ◯ | 10 |
| sample 38 | 30 | 12.5 | 3.5 | 4 | Au | 40 | 60 | 3 | 10 | 6.5 | ◯ | 15 |
| sample 39 | 30 | 12.5 | 3.5 | 4 | Ag | 40 | 0 | 3 | 10 | 18.3 | ◯ | 15 |
| sample 40 | 30 | 12.5 | 3.5 | 4 | Ag | 40 | 60 | 1 | 10 | 8.6 | ◯ | 15 |
| sample 41 | 30 | 12.5 | 3.5 | 4 | Au/Ag | 40 | 60 | 3 | 10 | 2.1 | ◯ | 15 |

| | | | | | | | | | |
|---|---|---|---|---|---|---|---|---|---|
| sample 42 | Bi₂O₃ 40 wt %, B₂O₃ 5 wt %, | Ag | 40 | 60 | 3 | 10 | 72.3 | ◯ | 25 |
| | SiO₂ 5 wt % | | | | | | | | |

The resistance value was measured in the electrode samples formed by performing printing, calcination at 350° C. for one hour, and self-cooling of conductive paste having dimensions of 50×100 mm and a thickness of 10 μm on a glass substrate.

The presence or absence of peeling was evaluated in the electrode samples formed by performing printing, calcination at 350° C. for one hour, and self-cooling of conductive paste having dimensions of 50×100 mm and a thickness of 10 μm on a glass substrate. A lattice pattern with cuts at one-millimeter intervals was made in the electrode samples, an adhesive tape was affixed thereto, and a tape peeling test was performed ten times. Samples with no peeling were evaluated as “◯” (good). Samples which showed peeling in the peeling test with the lattice pattern were subjected to a similar peeling test without using a lattice pattern of cuts, and any sample which showed no peeling was evaluated as “Δ” (acceptable) Any sample which showed peeling in both of the peeling tests was evaluated as “X” (bad).

The blackness indicating a reduction in contrast was evaluated with a reflection lightness L*value. Conductive paste was printed over the entirety of a glass substrate of 120×120 mm through a 200-mesh screen mask. After drying at 90° C. for 30 minutes, calcination was performed in the air at 350° C. for one hour, followed by self-cooling to form the electrode samples. The L*value was measured by a calorimeter CM2002 (manufactured by Konica Minolta Holdings, Inc.) in SCE (specular reflection excluded) mode. Reflected light at the interface between the glass and the black film was measured from the glass surface. As the value is smaller, the blackness is higher.

For any of the address electrode, bus electrode, bus main electrode, and black electrode, the glass component contained in the electrodes is the high-resistance glass, and especially, vanadium phosphate glass is preferable, and glass containing vanadium, phosphorus, antimony, and barium is more preferable. The glass desirably contains 45 to 65 wt % of V₂O₅, 15 to 30 wt % of P₂O₅, 2 to 25 wt % of BaO, and 5 to 30 wt % of Sb₂O₃. The metal desirably contains flaky particles, and more desirably, contains 50 to 90 wt % of flaky particles (having a diameter of 2 μm or more). If any of the components is absent, stable glass cannot be formed and the resulting electrode cannot reduce abnormal discharge, provide stability, or achieve sufficient adhesion between the electrode and the dielectric layer and/or the substrate.

Samples 15 to 19 and 22 to 27 containing vanadium, phosphorus, antimony, and barium in the glass components have lower L*values than that of sample 28 containing Bi-based glass and can provide an electrode having a higher blackness, and thus can reduce contrast when they are used for a PDP.

Samples 29 to 33 and 36 to 41 containing vanadium, phosphorus, antimony, and barium in the glass components have lower L*values than that of sample 42 containing Bi-based glass and can provide an electrode having a higher blackness, and thus can reduce contrast when they are used for a PDP.

Samples 1, 15, and 29 formed of glass having composition 60 wt % of V₂O₅, 25 wt % of P₂O₅, 7 wt % of BaO, and 8 wt % of Sb₂O₃ and silver particles (having an average diameter of 3 μm and containing 60% flaky particles and 40% spherical particles in the metal) have lower resistance values than those of samples 14, 28, and 42 containing similar silver particles in Bi-based insulating glass. When the high-resistance glass is used, the resistance value can be reduced as compared with the case where the insulating glass is used.

Samples 2 to 5, 16 to 19, and 30 to 33 different from electrode samples 1, 15, and 29 in the glass composition have poorer adhesion to the substrate or resistance values as compared with electrode samples 1, 15, and 29. The fact shows that composition of 60 wt % of V₂O₅, 25 wt % of P₂O₅, 7 wt % of BaO, and 8 wt % of Sb₂O₃ is desirable as the glass components contained in the electrode.

Samples 6, 20, and 34 containing no BaO and samples 7, 21, and 35 containing Sb₂O₃ are not preferable as electrodes since the glass frit was not formed into glass.

Samples 8, 22, and 36 containing flaky particles in the metal at a lower proportion (40 wt % in the metal) than in samples 1, 15, and 29 show insufficient adhesion between the metal particles forming the electrodes and exhibit higher resistance values. The flaky particles are desirably contained by 40 wt % or more in the metal.

Samples 11, 25, and 39 containing no flaky particles and consisting only of spherical particles showed higher resistance values than in samples 1, 15, and 29 containing flaky particles and samples 8, 22, and 36 containing flaky particles at a lower proportion (40 wt % in the metal). For use as the electrode, flaky particles are desirably contained.

Samples 9 and 23 containing metal particles at a lower proportion (40 wt %) than in samples 1 and 15 showed significantly higher resistance values since electric conduction was not sufficiently obtained between the metal particles. For use as the address electrode or bus electrode, metal is desirably contained by 70 wt % or more.

Samples 10, 24, and 38 containing gold used as the metal achieved lower resistance values than in electrode samples 14, 28, and 42 containing Bi-based glass, similarly to the case when the electrode was formed by using silver.

Samples 12, 26, and 40 formed by using metal particles having a smaller diameter (average diameter of 1 μm) than in samples 1, 15, and 29 showed higher resistance values than in samples 1, 15, and 29 since the former produced more Ag—V—O compound, Ag—P—C compound, and Ag—Sb—C compound due to reaction between the silver particles and the glass component. Samples 1, 15, and 29 contain 7% of Ag—V—C compound, Ag—P—C compound, and Ag—Sb—C compound, while samples 12, 26, and 40 contain 18 vol % of Ag—V—C compound, Ag—P—C compound, and Ag—Sb—C compound. For use as the address electrode or bus electrode, Ag—V—C compound, Ag—P—C compound, and Ag—Sb-compound are desirably contained by 10 vol % or less.

Samples 13, 27, and 41 formed by using flaky particles having an average diameter of 3 μm and made of a silver core and a gold shell as the metal (weight ratio of gold:silver is 1:20) can reduce reaction between the silver and glass component, oxidation and the like, and can provide lower resistance values than in samples 1, 15, and 29.

### EXAMPLE 2

Samples 1 to 5, 8, 10 to 13 containing vanadium phosphate glass and sample 14 containing Bi-based glass were used for the address electrode, and samples 15 to 19, 22, 24 to 27 containing vanadium phosphate glass and sample 28 containing Bi-based glass were used for the bus electrode to form a PDP. The number of abnormal discharge was observed.

Sample 1 containing vanadium phosphate glass and sample 14 containing Bi-based glass were used for the address electrode, sample 15 containing vanadium phosphate glass and sample 28 containing Bi-based glass were used for the bus main electrode, and samples 29 to 33, 36, and 38 to 41 containing vanadium phosphate glass and sample 42 containing Bi-based glass were used for the black electrode to form a PDP. The number of abnormal discharge was observed. Table 4 shows the results.

TABLE 4

| | |
|---|---|
| bus electrode | number of |

| | | | | |
|---|---|---|---|---|
| | address | bus main | black | abnormal |
| No. | electrode | electrode | electrode | discharges |

| | | | |
|---|---|---|---|
| PDP-1 | sample 1 | Sample 28 | 3 |
| PDP-2 | sample 2 | Sample 28 | 3 |
| PDP-3 | sample 3 | Sample 28 | 4 |
| PDP-4 | sample 4 | Sample 28 | 4 |
| PDP-5 | sample 5 | Sample 28 | 4 |
| PDP-6 | sample 8 | Sample 28 | 4 |
| PDP-7 | sample 10 | Sample 28 | 4 |
| PDP-8 | sample 11 | Sample 28 | 3 |
| PDP-9 | sample 12 | Sample 28 | 3 |
| PDP-10 | sample 13 | Sample 28 | 3 |
| PDP-11 | sample 14 | Sample 28 | 10 |
| PDP-12 | sample 14 | Sample 15 | 4 |
| PDP-13 | sample 14 | Sample 16 | 4 |
| PDP-14 | sample 14 | Sample 17 | 5 |
| PDP-15 | sample 14 | Sample 18 | 6 |
| PDP-16 | sample 14 | Sample 19 | 3 |
| PDP-17 | sample 14 | Sample 22 | 5 |
| PDP-18 | sample 14 | Sample 24 | 5 |
| PDP-19 | sample 14 | Sample 25 | 4 |
| PDP-20 | sample 14 | Sample 26 | 4 |
| PDP-21 | sample 14 | Sample 27 | 4 |
| PDP-22 | sample 1 | Sample 15 | 1 |

| | | | | |
|---|---|---|---|---|
| PDP-23 | sample 14 | Sample 28 | Sample 29 | 6 |
| PDP-24 | sample 14 | Sample 28 | Sample 30 | 6 |
| PDP-25 | sample 14 | Sample 28 | Sample 31 | 8 |
| PDP-26 | sample 14 | Sample 28 | Sample 32 | 7 |
| PDP-27 | sample 14 | Sample 28 | Sample 33 | 8 |
| PDP-28 | sample 14 | Sample 28 | Sample 36 | 8 |
| PDP-29 | sample 14 | Sample 28 | Sample 38 | 7 |
| PDP-30 | sample 14 | Sample 28 | Sample 39 | 7 |
| PDP-31 | sample 14 | Sample 28 | Sample 40 | 7 |
| PDP-32 | sample 14 | Sample 28 | Sample 41 | 6 |
| PDP-33 | sample 14 | Sample 28 | Sample 42 | 10 |
| PDP-34 | sample 14 | Sample 15 | Sample 42 | 6 |
| PDP-35 | sample 1 | Sample 15 | Sample 29 | 1 |
| PDP-36 | sample 14 | Sample 15 | Sample 29 | 3 |
| PDP-37 | sample 1 | Sample 28 | Sample 29 | 2 |

Test samples were provided as follows.

First, a transparent electrode made of ITO was formed on a glass substrate of five inches. A bus electrode or a bus main electrode and a black electrode were formed thereon. Then, dielectric paste was applied thereto, calcination was performed at 450° C., and an MgO layer was formed thereon to provide a front substrate.

Next, an address electrode was formed on a glass substrate of five inches, dielectric paste was applied thereto, calcination was performed, and a protecting film was formed thereon to provide a rear substrate.

A solvent and a dispersant were mixed into a mixture powder of glass and ceramic to form paste which was then printed as a spacer layer on the rear glass substrate, followed by calcination in the air at a temperature of 490 to 590° C. for one hour. The spacer layer after the calcination was processed into a stripe shape with a sandblast technique to form spacers. Next, a phosphor was applied to wall surfaces of the spacers. The spacers were calcinated at a temperature of 450° C.

For assembly of the test panel, the front substrate was affixed to the rear substrate and sealed hermetically by applying sealing glass paste to the peripheries of the substrates such that the opposed display electrode and address electrode are perpendicular to each other. The panel was sealed at a temperature of 450° C.

Next, the panel was evacuated through a P pipe on the periphery of the panel, and then a rare gas was introduced as a discharge gas and the P pipe is sealed. The discharge gas contained 10% of Xe (xenon). A pd product, which is a product of a discharge gas pressure p (Torr) and a distance d (mm) between discharge electrodes, was set to 200.

The panel thus formed was lit continuously for one hour, and the number of observed abnormal discharge was counted.

PDPs (PDP-1 to PDP-10) formed by using samples 1 to 5, 8, 10 to 13 containing vanadium phosphate glass for the address electrode and sample 28 containing Bi-based glass for the bus electrode showed a smaller number of abnormal discharges than in a PDP (PDP-11) formed by using sample 14 containing Bi-based glass for the address electrode and sample 28 containing Bi-based glass for the bus electrode. The use of vanadium phosphate glass for the address electrode was effective in reducing the abnormal discharge.

PDPs (PDP-12 to PDP-21) formed by using sample 14 containing Bi-based glass for the address glass and samples 15 to 19, 22, 24 to 27 containing vanadium phosphate glass for the bus electrode showed a smaller number of abnormal discharges than in a PDP (PDP-11) formed by using sample 14 containing Bi-based glass for the address electrode and sample 28 containing Bi-based glass for the bus electrode. The use of vanadium phosphate glass for the bus electrode was effective in reducing the abnormal discharge.

The PDPs (PDP-23 to PDP-32) formed by using sample 14 containing Bi-based glass for the address glass, sample 28 containing Bi-based glass for the bus main electrode, and samples 29 to 33, 36, and 38 to 41 containing vanadium phosphate glass for the black electrode showed a smaller number of abnormal discharges than in a PDP (PDP-33) formed by using samples containing Bi-based glass for the address electrode, bus main electrode, and black electrode. The use of vanadium phosphate glass for the black electrode was effective in reducing the abnormal discharge.

A PDP (PDP-34) formed by using sample 14 containing Bi-based glass for the address glass, sample 15 containing vanadium phosphate glass for the bus main electrode, and sample 42 containing Bi-based glass for the black electrode showed a smaller number of abnormal discharges than in a PDP (PDP-33) formed by using samples containing Bi-based glass for the address electrode, bus main electrode, and black electrode. A PDP (PDP-36) formed by using sample 14 containing Bi-based glass for the address glass, and samples 15 and 29 containing vanadium phosphate glass for the bus main electrode and black electrode showed a smaller number of abnormal discharges than in a PDP (PDP-23) formed by using samples 14 and 28 containing Bi-based glass for the address electrode and bus main electrode, and sample 29 containing vanadium phosphate glass for the black electrode. The use of vanadium phosphate glass for the bus main electrode was effective in reducing the abnormal discharge.

A PDP (PDP-22) formed by using vanadium phosphate glass for both of the address glass and bus electrode showed a smaller number of abnormal discharges than in PDPs (PDP-1 to PDP-21) formed by using Bi-based glass for at least one of the address electrode and bus electrode. The use of vanadium phosphate glass for both of the address electrode and bus electrode was effective in reducing the abnormal discharge.

A PDP (PDP-35) formed by using vanadium phosphate glass for all of the address glass, bus main electrode, and black electrode showed a smaller number of abnormal discharges than in PDPs (PDP-1 to PDP-21) formed by using Bi-based glass for at least one of the address electrode and bus main electrode or than in PDPs (PDP-23 to PDP-34, PDP-36, and PDP-37) formed by using Bi-based glass for at least one of the address electrode, bus main electrode, and black electrode. The use of vanadium phosphate glass for all of the address electrode, bus main electrode, and black electrode was effective in reducing the abnormal discharge.

It should be further understood by those skilled in the art that although the foregoing description has been made on embodiments of the invention, the invention is not limited thereto and various changes and modifications may be made without departing from the spirit of the invention and the scope of the appended claims.

1. A plasma display panel comprising:
a front substrate and a rear substrate which are provided opposite to each other;
an address electrode and a dielectric layer which are provided on the rear substrate;
a display electrode and a dielectric layer which are provided on the front substrate;
a plurality of spacers placed between the front substrate and the rear substrate; and
a phosphor put in space surrounded by the plurality of spacers, the front substrate, and the rear substrate,
wherein the display electrode is formed of a transparent electrode and a non-transparent electrode,
the peripheries of the front substrate and the rear substrate are sealed, and
at least one of the non-transparent electrode and the address electrode includes metal particles and high-resistance glass for binding the metal particles.

2. The plasma display panel according to claim 1, wherein the high-resistance glass is made of vanadium phosphate glass.

3. The plasma display panel according to claim 2, wherein the vanadium phosphate glass comprises vanadium, phosphorus, antimony, and barium.

4. The plasma display panel according to claim 1, wherein the metal particles contain flaky particles.

5. The plasma display panel according to claim 2, wherein the vanadium phosphate glass has composition of 45 to 65 wt % of V₂O₅, 15 to 30 wt % of P₂O₅, 2 to 25 wt % of BaO, and 5 to 30 wt % of Sb₂O₃.

6. The plasma display panel according to claim 4, wherein the flaky particles have a particle diameter of 2 μm or more.

7. The plasma display panel according to claim 1, wherein the address electrode is made of 70 to 95 wt % of metal particles and 5 to 30 wt % of high-resistance glass.

8. The plasma display panel according to claim 1, wherein the non-transparent electrode is made of 70 to 95 wt % of metal particles, 5 to 30 wt % of high-resistance glass, and 0 to 25 wt % of coloring pigment.

9. The plasma display panel according to claim 4, wherein the metal particles comprise 50 to 90 wt % of the flaky particles.

10. The plasma display panel according to claim 1, wherein the metal particles have a two-layered structure and a surface layer thereof is made of metal resistant to oxidation or reaction with a glass component.

11. A plasma display panel comprising:
a front substrate and a rear substrate which are provided opposite to each other;
an address electrode and a dielectric layer which are provided on the rear substrate;
a display electrode and a dielectric layer which are provided on the front substrate;
a plurality of spacers placed between the front substrate and the rear substrate; and
a phosphor filled in space surrounded by the plurality of spacers, the front substrate, and the rear substrate,
wherein the display electrode is formed of a transparent electrode, a black electrode provided on the transparent electrode, and a bus main electrode provided on the black electrode,
the peripheries of the front substrate and the rear substrate are sealed, and
at least one of the black electrode, the bus main electrode, and the address electrode includes metal particles and high-resistance glass for binding the metal particles.

12. The plasma display panel according to claim 11, wherein the high-resistance glass is made of vanadium phosphate glass.

13. The plasma display panel according to claim 12, wherein the vanadium phosphate glass comprises vanadium, phosphorus, antimony, and barium.

14. The plasma display panel according to claim 11, wherein the metal particles comprise flaky particles.

15. The plasma display panel according to claim 12, wherein the vanadium phosphate glass has composition of 45 to 65 wt % of V₂O₅, 15 to 30 wt % of P₂O₅, 2 to 25 wt % of BaO, and 5 to 30 wt % of Sb₂O₃.

16. The plasma display panel according to claim 14, wherein the flaky particles have a particle diameter of 2 μm or more.

17. The plasma display panel according to claim 11, wherein the address electrode is made of 70 to 95 wt % of metal particles and 5 to 30 wt % of high-resistance glass.

18. The plasma display panel according to claim 11, wherein the bus main electrode is made of 70 to 95 wt % of metal particles, 5 to 30 wt % of high-resistance glass, and 0 to 25 wt % of coloring pigment.

19. The plasma display panel according to claim 11, wherein the black electrode is made of 1 to 70 wt % of metal particles, 30 to 99 wt % of high-resistance glass, and 0 to 40 wt % of coloring pigment.
